(19) United States
(12) Patent Application Publication
(10) Pub. No.: US 2026/0097349 A1
(43) Pub. Date: Apr. 9, 2026

(54) PROCESS AND APPARATUS FOR THE DISTILLATION OF A MIXTURE OF CARBON DIOXIDE, CARBON MONOXIDE AND NITROGEN

(71) Applicant: L'Air Liquide, Societe Anonyme pour l'Etude et l’Exploitation des Procedes Georges Claude, Paris (FR)

(72) Inventors: Pascal MARTY, Paris (FR); Guillaume RODRIGUES, Paris (FR); Fabrice RIVOAL, Paris (FR); Laurette MADELAINE, Paris (FR)

(21) Appl. No.: 18/906,439

(22) Filed: Oct. 4, 2024

(51) Int. Cl. B01D 53/02; B01D 53/00; B01D 53/22; B01D 53/26

(52) U.S. Cl. CPC B01D 53/02; B01D 53/002; B01D 53/005; B01D 53/22; B01D 53/26; B01D 2256/20; B01D 2256/22

(57) ABSTRACT

In a process for the separation of a gas containing carbon dioxide, carbon monoxide, water and nitrogen, the gas is separated by adsorption to produce a gas enriched in carbon monoxide and a gas enriched in carbon dioxide, the gas enriched in carbon dioxide is cooled by indirect heat exchange with at least one gas originating from a distillation column, subsequently by indirect heat exchange with the bottom liquid from the distillation column, subsequently by heat exchange with two closed-circuit refrigeration cycles.

### CROSS-REFERENCE TO RELATED APPLICATIONS

This application claims the benefit of priority under 35 U.S.C. § 119 (a) and (b) to French patent application No. FR 2310716 filed Oct. 6, 2023, the entire contents of which are incorporated herein by reference.

### BACKGROUND

The present invention relates to a process and apparatus for the distillation of a mixture of carbon dioxide, carbon monoxide and nitrogen, for example a blast furnace gas from a blast furnace or another residual gas from a unit for the production of a ferrous metal.

### FIELD OF THE INVENTION

A blast furnace gas from a blast furnace contains between 15 mol % and 35 mol % of carbon monoxide.

The typical molar composition of a blast furnace gas from a blast furnace is as follows:
H₂: 4-5%
CO: 24-25%.
CO₂: 23-25%
N₂: 40-45%.
H₂O: 3%

The aim of the extractions of the CO₂ and of the N₂ present in the blast furnace gases from blast furnaces is to upgrade them:
as fuel to gas turbines (for example for the generation of electricity for an integrated steel mill) or to other users of the steel mill (such as heat-recovery apparatuses for blast furnaces as a mixture with other fuel gases (coke oven gas or natural gas) to preheat the enriched air),
as reducing gas for the coal in the blast furnace itself,
as starting material for the production of biofuels.

### RELATED ART

Several technologies for the extraction/separation of the CO₂ can be envisaged: pressure swing adsorption (PSA) or scrubbing with amines. The separation of the nitrogen from the CO is more difficult.

The blast furnace produces a blast furnace gas which is at low pressure, subsequently compressed by a compressor and sent to be separated by adsorption to produce a flow enriched in CO and depleted in CO₂ also containing hydrogen and nitrogen and a flow enriched in CO₂ and depleted in CO also containing hydrogen.

In the case of a PSA treating a blast furnace gas compressed to approximately 8-10 bar, the yield for recovery of the CO at high pressure is typically greater than 80% (indeed even than 85%), for corresponding yields for the extraction of CO₂ at low pressure in the region of 88% and of N₂ of 15%.

It is sought both to maximize the yield for recovery of CO and the yields for extraction of CO₂/N₂.

A pretreatment of the blast furnace gas (capture of the particles and of certain undesirable compounds) may be necessary upstream of the PSA.

The stream enriched in CO generated by the PSA thus also contains a great deal of nitrogen (approximately 85 mol % of the flow of blast furnace gas treated) because the CO/N₂ selectivity is very low on conventional adsorbents. It also contains hydrogen and CO₂ (approximately 12% of the flow of blast furnace gas treated).

The flow enriched in CO₂ produced at low pressure by the PSA also contains non-adsorbed CO (approximately 15% of the flow of blast furnace gas treated), H₂, nitrogen and water present in the blast furnace gas.

WO2012/076786 describes a process for the treatment of blast furnace gas in which the compressed blast furnace gas feeds a PSA, the product from the PSA is returned to the blast furnace and the residual from the PSA is separated at a temperature of less than 0° C.

US2022/0306464 describes a process in which the gas to be cooled is cooled by two exchangers in parallel, liquid from the column being sent to the two exchangers. A part of the reboiling of the column is provided by the pressurized product.

Example of material balance obtained for a PSA operating in “High-CO Yield” mode on blast furnace gas at approximately 8 bar (numerical references corresponding to [FIG. 1]):

TABLE 1

| | | Flow enriched | Flow enriched |
|---|---|---|---|
| | | in CO | in CO₂ |
| | PSA inlet 5 | 7 | 9 |
| Molar flow | 100 | 67 | 33 |
| H₂ | 5 | 8 | 1 |
| CO | 25 | 32 | 11 |
| CO₂ | 26 | 5 | 68 |
| N₂ | 43 | 55 | 18 |
| H₂O | 1 | 0 | 2 |

CO recovery yield = 85.8%
N₂/CO ratio approx. 1.72 PSA inlet and in the CO-rich gas (PSA product)

It is known to separate the H₂ PSA residual gas enriched in CO₂ produced at low pressure in order to extract the CO₂ in liquid or gaseous form by partial condensation and/or by distillation. The aim of this separation is then to separate the CO₂ from the H₂, the latter being upgraded by retreatment in the PSA. This idea can be applied to the residual gas from a PSA positioned on a blast furnace gas from a blast furnace, in order to separate the CO₂ from the CO. The CO/H₂-rich gas thus produced can thus be upgraded, either as fuel or as product, with or without reprocessing.

### SUMMARY OF THE INVENTION

According to a subject-matter of the invention, there is provided a process for the separation of a gas containing carbon dioxide, carbon monoxide, water and nitrogen, in which:
i) the gas is separated by adsorption or permeation to produce a gas enriched in carbon monoxide and depleted in carbon dioxide and a gas depleted in carbon monoxide and enriched in carbon dioxide,
ii) the gas enriched in carbon dioxide is dried, compressed and cooled, being first cooled by indirect heat exchange with at least one gas originating from a distillation column, no liquid originating from the column participating in the heat exchange subsequently by indirect heat exchange with the bottom liquid from the distillation column, subsequently by heat exchange with a closed-circuit ammonia refrigeration cycle, subsequently by heat exchange with a closed-circuit CO₂ or propane refrigeration cycle, being partially condensed by the last of the refrigeration cycles,
iii) the partially condensed gas is sent to a phase separator, the liquid from the phase separator is expanded and sent to the top of the distillation column in order to be separated therein, without having been heated upstream of the expansion, and the gas from the phase separator is heated by indirect heat exchange with the dried and compressed gas enriched in carbon dioxide,
iv) the bottom liquid is vaporized by the heat exchange with the gas and the vaporized liquid is sent to the bottom of the column as sole reboiling gas, and
v) a CO₂-rich liquid is extracted at the bottom of the column.

According to other optional aspects:
another part of the CO₂-rich liquid is vaporized by indirect heat exchange with the dried, compressed and cooled gas enriched in carbon dioxide to form a CO₂-rich gaseous product,
a top gas from the column is heated by indirect heat exchange with the dried and compressed gas enriched in carbon dioxide,
a plate and fin heat exchanger is used to cool the dried and compressed gas enriched in carbon dioxide against the other part of the CO₂-rich liquid and/or
the top gas from the column and/or the gas from the phase separator,
in the at least one refrigeration cycle, a refrigerant is compressed by a screw or piston compressor, cooled, expanded, condensed, reheated and vaporized by heat exchange with the dried and compressed gas enriched in carbon dioxide which has already been used to vaporize the bottom liquid and returned to the compressor,
the dried and compressed gas enriched in carbon dioxide which has already been used to vaporize the bottom liquid is cooled by a first refrigeration cycle, for example down to a temperature between −28° C. and −30° C., in which a first refrigerant is compressed by a first screw or piston compressor, cooled, expanded, reheated by heat exchange with the dried and compressed gas enriched in carbon dioxide which has already been used to vaporize the bottom liquid and returned to the first compressor,
the dried and compressed gas enriched in carbon dioxide which has already been cooled by the first refrigeration cycle is cooled by a second refrigeration cycle, for example down to a temperature between −52° C. and −53° C., in which a second refrigerant is compressed by a second screw or piston compressor, cooled, expanded, reheated by heat exchange with the dried and compressed gas enriched in carbon dioxide which has already been cooled by the first refrigeration cycle and returned to the second compressor,
a part of the first expanded and condensed refrigerant is used to cool the second refrigerant after compression in the second compressor and before its expansion, the part of the first refrigerant being vaporized by heat exchange with the second refrigerant in a heat exchanger,
the part of the first refrigerant used to cool the second refrigerant is at the same temperature as the part of the first refrigerant sent to cool the gas enriched in carbon dioxide,
the column operates at a pressure of less than or equal to 21 bar abs,
the column operates at a pressure between 10 and 15 bar abs, indeed even between 12 and 14 bar, and the carbon dioxide is produced at a pressure of less than 10 bar abs,
the gas to be separated contains between 15 mol % and 35 mol % of CO,
the CO₂-rich liquid contains at least 80 mol % of CO₂, indeed even at least 90 mol % of CO₂ or even 95 mol % of CO₂,
the CO₂-rich liquid extracted at the bottom of the column is supplied to a client at 7 bara after subcooling and expansion and the pressure of the gas enriched in carbon dioxide which exchanges heat with the bottom liquid from the distillation column is between 30 and 40 bara.

According to another subject-matter of the invention, there is provided an apparatus for the separation of a gas containing carbon dioxide, carbon monoxide, water and nitrogen, comprising a unit for separation by adsorption or by permeation, means for sending the gas to be separated in the separation unit in order to produce a gas enriched in carbon monoxide and depleted in carbon dioxide and a gas depleted in carbon monoxide and enriched in carbon dioxide, a dryer, a compressor, means for sending the gas enriched in carbon dioxide to be dried in the dryer and compressed in the compressor, a first means for cooling by indirect heat exchange with at least one gas originating from a distillation column, no liquid originating from the column participating in the heat exchange, a second means for cooling by indirect heat exchange with the bottom liquid from the distillation column, a third means for cooling by heat exchange with a first closed-circuit ammonia refrigeration cycle, a fourth means for cooling by heat exchange with a second closed-circuit CO₂ or propane refrigeration cycle, means for sending the gas compressed in the compressor successively to the first, to the second, to the third and to the fourth cooling means, being partially condensed by the last of the refrigeration cycles, a phase separator, means for sending the partially condensed gas to the phase separator, means for expanding the liquid from the phase separator and for sending it to the top of the distillation column in order to be separated therein, without having been heated upstream of the expansion, and means for sending the gas from the phase separator to be heated by indirect heat exchange with the dried and compressed gas enriched in carbon dioxide, means for sending the bottom liquid vaporized by the heat exchange with the gas to the bottom of the column as sole reboiling gas and means for extracting a CO₂-rich liquid at the bottom of the column.

The first or second refrigeration cycle can comprise a screw or piston compressor for compressing the refrigerant, means for cooling, expanding, condensing, heating and vaporizing the refrigerant by heat exchange with the dried and compressed gas enriched in carbon dioxide which has already been used to vaporize the bottom liquid and returned to the compressor.

### BRIEF DESCRIPTION OF THE FIGURES

The invention will be illustrated in greater detail with reference to the figures, where:

FIG. 1 illustrates a separation unit according to the invention

FIG. 2 illustrates an optional part of a separation unit according to the invention

FIG. 3 illustrates an optional part of a separation unit according to the invention

FIG. 4 is a graph illustrating the relationship between the specific energy of a separation unit according to the invention and the pressure of the column.

### DETAILED DESCRIPTION OF THE INVENTION

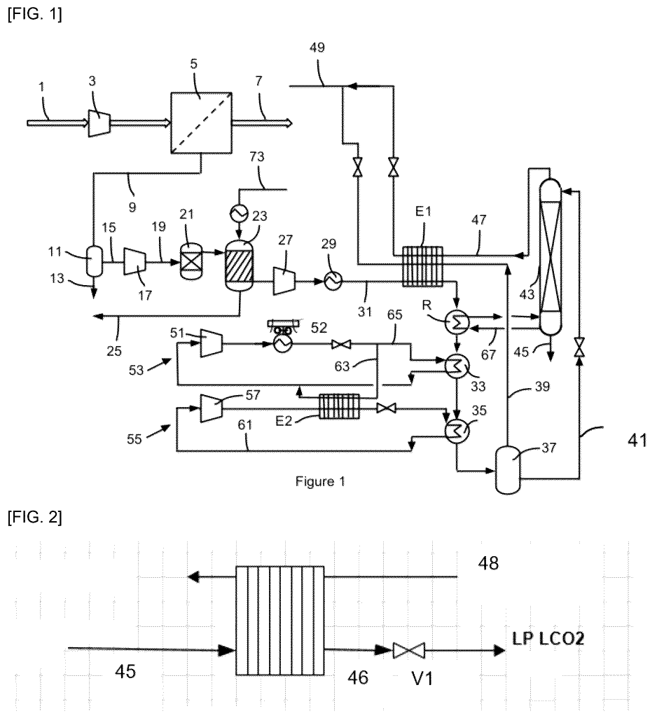

FIG. 1 illustrates a separation unit, the distillation part of which is carried out at less than 0° C., making it possible to extract the CO₂ 45 from a residual gas from a pressure swing adsorption unit 5 of PSA type, the unit 5 treating the blast furnace gas 1 from a blast furnace. The unit 5 produces a gas flow 7 enriched in CO, in nitrogen and in hydrogen and depleted in CO₂ and in water and a gas flow 9 enriched in CO₂ and in water and depleted in CO, in nitrogen and in hydrogen, constituting the residual gas from the PSA at low pressure.

The unit 5 can alternatively separate the blast furnace gas by permeation or by another type of adsorption.

The gas flow 7 can be returned to the blast furnace or used to produce bioethanol.

The separation unit includes:
dryers 23 for extracting the water contained in the residual gas from the PSA,
optionally at least one membrane separation unit for extracting the CO and the H₂ from the CO₂,
a compressor 17, 27 for residual gas 15, 19,
two refrigeration cycles (NH₃ and C₃ and/or CO₂,
a condensation of the CO₂ upstream of a phase separator 37,
a stripping column 43 producing purified CO₂ at least in the liquid form 45,
a heat exchanger E1 which makes it possible to cool the compressed residual gas 31 from the adsorption unit 5 and to vaporize the purified CO₂ 45, if required.

A size of at most 1000 t/d of CO₂ is typical.

In this example, the water vapour present in the blast furnace gas 1 from the blast furnace is adsorbed by the adsorption unit 5. The wet residual gas 9 from the adsorption unit 5 is dried by passing through the vessel 11, where water and/or other condensates 13 are removed. The dried flow 15 is compressed in a compressor 17 forming the gas 19, then dried by adsorption of TSA type in a dryer 23 at the inlet of the separation unit operating at low temperature. The dryers are generally located at one of the inter-stages of the compressor 17, 27 for residual gas 19 (but not necessarily).

The regeneration of the dryer 23 can be carried out by an external gas 73 not generated by the low-temperature separation unit (a nitrogen-rich gas, for example) or by virtue of the use of a dry stream generated by the low-temperature separation unit, for example the gas 39 and/or the gas 47. The wet gas 25, which is the gas 73 laden with water, can be:
either recycled at a point upstream of the dryers 23, indeed even of the PSA adsorption unit 5 (itself to increase the recovery yields of the H₂/CO molecules (possibly present in the regeneration gas 73 and the products from the PSA) and of the CO₂ 45),
or is exported as fuel.

The regeneration of the dryer 23 can be carried out at low or at high pressure.

The water content in the residual gas 19 prior to the dryers 23 can be reduced by a preliminary treatment of the scrubbing with water type in a tower 21. This tower 21 may not only make it possible to remove solid particles and soluble impurities but also to cool the gas 19 upstream of the dryer 23.

The residual gas 31, dried and compressed to a pressure between 20-60 bar, typically 40-45 bar, in the compressor 27, is subsequently cooled to the vicinity of −50° C. in order to partially condense a CO₂-rich phase and is sent to a phase separator 37. The liquid 41 from the phase separator 37 feeds the column 43. The gas phase 39 originating from the separator 37 predominantly contains the compounds which are lighter than CO₂ but also non-condensed CO₂. The condensation temperature of the residual gas 31 will be limited (in general to the vicinity of −52° C.) so as to avoid the risk of formation of CO₂ crystals at any point of the process. The residual gas 31 can be cooled by a certain number of fluids:
water in the cooler 29,
the gas fraction 39 from the separator 37 in a plate and fin exchanger E1, for example,
the top gas 47 from the CO₂ stripping column 43 in a plate and fin exchanger E1, for example,
two external refrigerants (NH₃, C₃H₈, CO₂) generated by conventional cold cycles (compression/expansion of the refrigerating medium), which are or are not integrated with one another,
the reboiler R of the CO₂ stripping column 43.

The CO₂-rich liquid 41 originating from the separator 37 is subsequently expanded (typically to a pressure in the vicinity of 20 bar) and sent to the stripping column 43. The formation of solid is prevented by the regulation of the column at a sufficient pressure such that T≥−54.5° C. after the expansion valve without preheating of the CO₂-rich stream 41 before the expansion valve.

In the example of the figure, the residual gas was cooled in the heat exchanger E1 and subsequently in the reboiler R by heat exchange with the bottom liquid 67 from the column 43.

Subsequently, the residual gas cooled to approximately −12° C. is cooled in a heat exchanger 33 by indirect heat exchange with a first closed-circuit refrigeration cycle, for example having ammonia.

In this first cycle 53, a first refrigerant is compressed in a screw or piston compressor 51 up to a pressure of greater than 14 bar abs, cooled down to 35° C. by a water cooler 52, expanded in a valve down to atmospheric pressure and a temperature of −30° C. to form a liquid and sent to the exchanger 33 to cool the residual gas down to between −28° C. and −30° C. The first refrigerant, heated and vaporized in the heat exchanger 33, is sent to the compressor 51.

All of the first refrigerant can be sent to the exchanger 33 and subsequently to the compressor 51. According to an alternative form, the first refrigerant expanded in the valve is divided into two liquid parts 63, 65, only the part 65 being sent to the exchanger 33 in order to cool the residual gas down to between −28° C. and −30° C., and the other part 63, at the same temperature as the part 65, being heated and vaporized in a heat exchanger E2 by indirect heat exchange with the second refrigerating cycle. The two heated and vaporized parts are subsequently mixed and sent to the compressor 51.

The residual gas cooled in the exchanger 33 down to between −28° C. and −30° C. continues its cooling in the exchanger 35 by indirect heat exchange with the second closed-circuit refrigerant cycle where a second refrigerant, which can be CO₂ or propane, circulates.

The second refrigerant is compressed in a screw or piston compressor 57 from a pressure of 5.5 bar up to a pressure of greater than 16 bar, the second compressed refrigerant being cooled in the exchanger E2 against the first liquefied refrigerant 63, expanded down to 5.5 bara and a temperature of −54° C. in a valve, and sent to the heat exchanger 35 at −54° C. and 5.6 bara in the liquid form in order to cool the residual gas down to between −52° C. and −53° C. The second refrigerant, heated in the heat exchanger 35, is sent as flow 61 to the inlet of the compressor 57.

The vaporization of the first refrigerant 63 in the heat exchanger E2 at −30° C. makes it possible to cool the second refrigerant down to −28° C., thus to gain with regard to the rate of expansion of the second refrigeration cycle 55.

The presence of the exchanger E2 connecting the two cycles 53, 55 is optional.

The residual gas leaves the heat exchanger 35 at −52° C. in the two-phase form.

For each given compression pressure, there exists a minimum stripping column 43 pressure which prevents the formation of solid after the valve for expansion of the liquid 41. The formation of solid CO₂ appears in the vicinity of −56.4° C. It is desirable to retain a spacing of 2° C. with respect to this temperature, that is to say to obtain a temperature at the lowest of −54.4° C. downstream of the valve for expansion with respect to the liquid 41.

The lower the chosen compression pressure, the more the pressure of the stripping column 43 can be reduced; however, the specific energy associated with the capture of the CO₂ increases greatly when the compression pressure is less than 30 bar, due to a large portion of non-condensed gas recycled to the adsorption unit 5, and thus compressed in a loop. However, at a compression pressure of less than 20 bar, the scheme requires a missing compression stage.

With the claimed scheme, it is thus possible to produce the liquid CO₂ 45 directly at pressures of less than 20 bar without preheating the CO₂-rich stream 41 upstream of the expansion valve, even if this is not the energy optimum.

The stripping column 43 makes it possible to extract the gases lighter than CO₂, for example H₂, CO, N₂ and other impurities present in the CO₂.

The specification required for the CO₂ at the bottom of the column 43 will be obtained by adjusting the stripping parameters, for example the bottom reboiling ratio. The degree of condensation at the top of the stripping column is provided by the level of expansion of the CO₂-rich liquid 41. The heat required for the reboiling R can be taken from the compressed residual gas 31.

The gas phase 39 originating from the separator 37 is heated by the compressed residual gas 31 in the exchanger E1, generating a first fluid. The top gas 47 from the column 43 is heated by the compressed residual gas 31, generating a second fluid.

The first and second fluids are combined to form a residual gas 49.

If the purified CO₂ 45 has to be produced in liquid form, it will be directly withdrawn from the bottom of the stripping column 43.

If the purified CO₂ has to be produced in gaseous form (not represented), it can be partly vaporized by the compressed residual gas 31 from the PSA before passing through the heat exchanger E1 and being exported (not represented).

The recovery of the cold from the purified liquid CO₂ 45 also makes it possible to reduce the additional cold requirements for the cooling of the compressed residual gas 31 and thus to also reduce the energy consumptions of the external cold cycles 53, 55.

A typical material balance of the process is shown below:

TABLE 2

| | Gas enriched | CO₂-rich | | | Liquid |
|---|---|---|---|---|---|
| | in CO₂ | liquid | Gas | Gas | CO₂ |
| | 9 | 41 | 39 | 47 | 45 |
| Pressure | 1.05 | 45 | 45 | 21 | 21 |
| bara | | | | | |
| T ° C. | 40 | −52 | −52 | −53 | −20 |
| Flow mol % | 100 | 65 | 35 | 6 | 59 |
| H₂ | 1 | 0 | 2.9 | 0.2 | 0 |
| CO | 11 | 2.2 | 29.9 | 24.6 | 0 |
| CO₂ | 68 | 94.1 | 21.2 | 33.9 | 100 |
| N₂ | 18 | 3.7 | 46 | 41.3 | 0 |
| H₂O | 2 | 0 | 0 | 0 | 0 |
| N₂/CO | | | 1.53 | 1.7 | |
| ratio | | | | | |

The optimization of the residual gas compressor 17, 27 and of the external cold cycles makes it possible to obtain specific energy consumptions of the order of 200 kW/ton liquid CO₂ produced.

It is possible to associate, with each given compression pressure, an operating pressure range for the column, making it possible both:
to prevent the formation of solid (minimum pressure),
to optimize the thermal integration with the reboiling (maximum pressure).

The specific energy decreases with the increase in the pressure of the stripping column, resulting in a liquid CO₂ product at higher pressure. Below a compression pressure of 30 bar, the specific energy greatly increases.

With the claimed scheme, it is advantageous to produce the liquid CO₂ at a pressure greater than 8 bar, preferentially greater than 12 bar (pressure of the stripping column) if it is sought to minimize the specific energy.

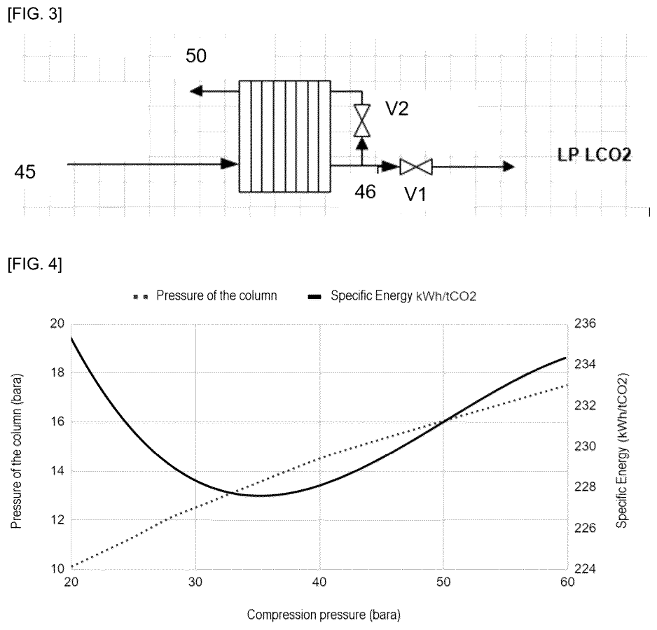

If it was desired to produce liquid CO₂ at a lower pressure (that is to say, at a lower pressure than the minimum pressure of the stripping column), it would be necessary to subcool the liquid CO₂ 45 produced by the stripping column 43 (down to −52° C., for example) before expanding it, as illustrated in FIGS. 2 and 3.

In FIG. 2, the liquid 45 is cooled in a heat exchanger E3 by heat exchange with an external fluid 48 forming cooled liquid 46 which is subsequently expanded in a valve V1. This liquid 46 constitutes the product at lower pressure.

In FIG. 3, the liquid 45 is cooled in a heat exchanger E3, taking a part 50 of the liquid, expanding it in a valve V2 and sending it to the heat exchanger E3, leaving another part 46 of the liquid, which is subsequently expanded in the valve V1. This liquid 46 constitutes the product at lower pressure. This process corresponds to that of FR 3 122 918 B.

The processes of FIGS. 2 and 3 make it possible to expand the liquid 45 of FIG. 1. In this case, it is possible, for example, to produce liquid CO₂ at 7 bar with 100 ppm of CO and a CO₂ purity >99.9% starting from the blast furnace gas composition 1 mentioned on the first page of this document.

FIG. 4 shows the change in the minimum pressure of the stripping column 43 and in the specific energy for producing the liquid CO₂ 45 at 7 bar after subcooling and expansion (as illustrated in FIGS. 2 and 3) as a function of the compression pressure of the residual gas 31.

The temperature of the liquid CO₂ downstream of the exchanger E3 and upstream of the valve V1 is equal to or less than −50° C. The pressure to which the CO₂ is expanded by the valve V1 is 7 bar and the temperature of the expanded CO₂ is equal to or less than the liquid equilibrium temperature at 7 bar.

In order to produce the liquid CO₂ at 7 bar, the production of liquid CO₂ 45 is subcooled to T≤−50° C. (downstream of the exchanger E3 and upstream of the valve V1) before expanding the liquid in the valve V1. This subcooling can be carried out:
via the existing external refrigerating unit for CO₂ (in cascade with the NHs cycle)—FIG. 2,
or else by expansion in the valve V2 of a fraction 50 of the production, making possible a spacing of at least 2° C. in the exchanger E3—FIG. 3; this fraction 50 can be recycled at an inter-stage of the line for compression 17, 27 of the residual gas, if it is desired to improve the yield for recovery of the CO₂.

The specific energy exhibits a minimum for a compression pressure of the residual gas 31 between 30 and 40 bar. The specific energy is reduced with the installation of an existing external cycle.

The specific energy for the production of liquid CO₂ at 7 bar varies by less than 1% between the schemes at minimum stripping column pressure and at maximum stripping column pressure: this is because the separation is facilitated by a column at higher pressure but the subcooling demands more energy.

It is possible to directly produce liquid CO₂ at 7 bar in the stripping column. The compression of the residual gas 31 can then be limited to 10 bar. The specific energy calculated in the case of our example is 260 kWh/t CO₂. This scheme exhibits the advantage of having a residual gas compressor of reduced size.

It is possible to produce liquid CO₂ at 7 bar without risk of formation of solid for a lower energy (˜230 kWh/t CO₂) by expansion of the liquid production from the stripping column 43 operated at a pressure of greater than 7 bar after subcooling. There exists an optimum between 30 and 40 bar of compression of the residual gas 9, 31 with a column 43 working between 10 and 25 bar. The specific energy becomes lower the lower the pressure of the column 43, and the subcooling provided by an external cycle (that is to say, a closed, separate, refrigeration loop with compressor, water condenser and vaporization by indirect contact with the process). On the other hand, the residual gas compressor 17, 27 will be larger.

With the scheme according to the invention, if it is desired to produce liquid CO₂ at a pressure P1 of less than 12 bar, it will be preferable:
to compress the residual gas to a pressure of 30 to 40 bar,
to operate the stripping column 43 at a pressure of 10 to 25 bar,
to subcool the liquid production before expansion with a closed external CO₂ cycle,
   instead of directly producing the CO₂ at the required pressure P1.

Example: Production of gaseous CO₂ at 7 bar with the scheme according to the invention: → for a compression pressure of the residual gas 31 of 45 bar, the minimum operating pressure of the stripping column 43 is 15 bar. The fluid at 45 bar is cooled to −52° C., the liquid fraction 41, expanded to 15 bar (and at −54.5° C.), is introduced into the stripping column 43. 38% (flow 50) of the liquid production 45 (15 bar, −28° C.) is expanded to 5.7 bar (−54° C.) in order to be able to cool the fluid 46 to −52° C. (and assuming 2° C. of spacing in the exchanger). The fluids MP (medium pressure) 46 and BP (low pressure) 50 are heated in the heat exchanger E1. The fluid MP 46 is subsequently expanded to 7 bar, the fluid BP 50 is compressed up to 7 bar and they are mixed to form the gaseous CO₂ product at 7 bar. The specific energy is 160 kWh/t CO₂. If the gaseous CO₂ has to be produced at a pressure greater than the pressure of the stripping column, the fluid MP 46 is not expanded and the compression of the fluids BP 50 and MP 46 is combined.

In order to avoid the addition of a machine for compressing the product, the fluid BP 50 can be expanded to (7 bar+pressure drop) before the heat exchanger E1, the fluid MP 46 remaining expanded to 7 bar after the heat exchanger E1, and then the fluid MP 46 and the fluid BP 50 are mixed.

In this case, the fluid 31 can no longer be cooled to −52° C. but to a higher temperature (in the example of a compression pressure of the residual gas of 45 bar, to −46.5° C.). The recycled gas fraction 39 is thus greater and the specific energy increases (+7 kWh/t CO₂ in the example). On the other hand, the minimum pressure of the column is lower than in the preceding case (10.8 bar in our example).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”: “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for the separation of a gas containing carbon dioxide, carbon monoxide, water and nitrogen, comprising:
i) separating the gas by adsorption or permeation to produce a gas enriched in carbon monoxide and depleted in carbon dioxide and a gas depleted in carbon monoxide and enriched in carbon dioxide,
ii) drying, compressing, and cooling the gas enriched in carbon dioxide, being first cooled by indirect heat exchange with at least one gas originating from a distillation column, no liquid originating from the column participating in the heat exchange, subsequently by indirect heat exchange with the bottom liquid from the distillation column, subsequently by heat exchange with a first closed-circuit ammonia refrigeration cycle, subsequently by heat exchange with a second closed-circuit CO₂ or propane refrigeration cycle, being partially condensed by the last of the refrigeration cycles,
iii) sending the partially condensed gas to a phase separator, the liquid from the phase separator is expanded and sent to the top of the distillation column in order to be separated therein, without having been heated upstream of the expansion, and the gas from the phase separator is heated by indirect heat exchange with the dried and compressed gas enriched in carbon dioxide,
iv) vaporizing the bottom liquid by the heat exchange with the gas and the vaporized liquid is sent to the bottom of the column as sole reboiling gas, and
v) extracting a CO₂-rich liquid at the bottom of the column.

2. The process according to claim 1, wherein, in the first or second refrigeration cycle, a refrigerant is compressed by a screw or piston compressor, cooled, expanded, condensed, reheated and vaporized by heat exchange with the dried and compressed gas enriched in carbon dioxide which has already been used to vaporize the bottom liquid and returned to the compressor.

3. The process according to claim 2, wherein the dried and compressed gas enriched in carbon dioxide which has already been used to vaporize the bottom liquid is cooled by the first refrigeration cycle, in which ammonia is compressed by a first screw or piston compressor, cooled, expanded, reheated by heat exchange with the dried and compressed gas enriched in carbon dioxide which has already been used to vaporize the bottom liquid and returned to the first compressor.

4. The process according to claim 3, wherein the dried and compressed gas enriched in carbon dioxide which has already been cooled by the first refrigeration cycle is cooled by the second refrigeration cycle, in which CO₂ or propane is compressed by a second screw or piston compressor, cooled, expanded, reheated by heat exchange with the dried and compressed gas enriched in carbon dioxide which has already been cooled by the first refrigeration cycle and returned to the second compressor.

5. The process according to claim 4, wherein a part of the expanded and condensed ammonia is used to cool the CO₂ or the propane after compression in the second compressor and before expansion, the part of the ammonia being vaporized by heat exchange with the CO₂ or the propane in a heat exchanger.

6. The process according to claim 5, wherein the part of the ammonia used to cool the CO₂ or the propane is at the same temperature as the part of the ammonia sent to cool the gas enriched in carbon dioxide.

7. The process according to claim 1, wherein the column operates at a pressure of less than or equal to 21 bar abs.

8. The process according to claim 1, wherein the column operates at a pressure between 10 and 15 bar abs and the carbon dioxide is produced at a pressure of less than 10 bar abs.

9. The process according to claim 1, wherein the gas to be separated contains between 15 mol % and 35 mol % of CO.

10. The process according to claim 1, wherein the CO₂-rich liquid contains at least 80 mol % of CO₂.

11. The process according to claim 1, wherein the CO₂-rich liquid extracted at the bottom of the column is supplied to a client at 7 bara after subcooling and expansion and the pressure of the gas enriched in carbon dioxide which exchanges heat with the bottom liquid from the distillation column is between 30 and 40 bara.

12. An apparatus for the separation of a gas containing carbon dioxide, carbon monoxide, water and nitrogen, comprising a unit for separation by adsorption or by permeation, a means for sending the gas to be separated in the separation unit in order to produce a gas enriched in carbon monoxide and depleted in carbon dioxide and a gas depleted in carbon monoxide and enriched in carbon dioxide, a dryer, a compressor, a means for sending the gas enriched in carbon dioxide to be dried in the dryer and compressed in the compressor, a first means for cooling by indirect heat exchange with at least one gas originating from a distillation column, no liquid originating from the column participating in the heat exchange, a second means for cooling by indirect heat exchange with the bottom liquid from the distillation column, a third means for cooling by heat exchange with a first closed-circuit ammonia refrigeration cycle, a fourth means for cooling by heat exchange with a second closed-circuit CO₂ or propane refrigeration cycle, means for sending the gas compressed in the compressor successively to the first, to the second, to the third and to the fourth cooling means, being partially condensed by the last of the refrigeration cycles, a phase separator, a means for sending the partially condensed gas to the phase separator, a means for expanding the liquid from the phase separator and for sending the expanded liquid to the top of the distillation column in order to be separated therein, without having been heated upstream of the expansion, and means for sending the gas from the phase separator to be heated by indirect heat exchange with the dried and compressed gas enriched in carbon dioxide, a means for sending the bottom liquid vaporized by the heat exchange with the gas to the bottom of the column as sole reboiling gas and means for extracting a CO₂-rich liquid at the bottom of the column.

13. The apparatus according to claim 12, wherein the first or second refrigeration cycle comprises a screw or piston compressor for compressing the refrigerant, a means for cooling, expanding, condensing, heating and vaporizing the refrigerant by heat exchange with the dried and compressed gas enriched in carbon dioxide which has already been used to vaporize the bottom liquid and returned to the compressor.
